(19) United States
(12) Patent Application Publication
(10) Pub. No.: US 2010/0281621 A1
(43) Pub. Date: Nov. 11, 2010

(54) COMBINATION TOOL WITH HAMMER AND WRENCH HEADS

(76) Inventor: Ursus MORITZ, Fort St. John (CA)

Correspondence Address: NEXUS LAW GROUP LLP, 1500 - 701 WEST GEORGIA STREET, VANCOUVER, BC, V7Y 1C6, CA

(21) Appl. No.: 12/550,673

(22) Filed: Aug. 31, 2009

(30) Foreign Application Priority Data
May 6, 2009 (CA) 2665571

(51) Int. Cl. B25F 1/00; B25D 1/12

(52) U.S. Cl. 7/147; 81/22

(57) ABSTRACT

According to the present invention there is provided a combination tool with a hammer and wrench. The tool may include an elongated handle having a first and a second end and a hammer head formed substantially perpendicularly and extending from the first end of the elongated handle. The tool may further include a circumferential wrench wall formed substantially perpendicularly and extending from the first end of the elongated handle and substantially longitudinally and extending away from the hammer head. The wrench wall may include an outer wall surface and an inner wall surface, wherein the inner wall surface may have a cross-sectional perimeter shaped to define a bolt head pattern.

### COPYRIGHT NOTICE

This patent document contains material which is subject to copyright protection. The copyright owner has no objection to the facsimile reproduction by anyone of this patent document as it appears in the Patent and Trademark Office patent file or records, but otherwise reserves all copyright rights whatsoever.

### FIELD OF THE INVENTION

The invention relates to the field of combination tools and in particular to a combined hammer, wrench, and pin bar tool for use with excavator buckets in the mining industry.

### BACKGROUND OF THE INVENTION

Excavators are frequently used in mining operations. When an excavator requires a new bucket, a service technician will typically use three different tools: a conventional sledge hammer for pounding the excavator buckets into place, a wrench for loosening and tightening excavator bucket bolts, and a pin bar for scraping off mud and debris found on the excavator buckets.

With the above conventional tools, one is able to change an excavator bucket in the field. However, the technician must ensure that he has all the necessary tools in his tool bag in order to change an excavator bucket and once there, must reach for a specific tool each time a new task (i.e. pounding, loosening, scraping) is required. Forgetting to bring any one of the conventional tools into the field is is quite common. Furthermore, using these individual conventional tools by having to reach for a new tool each time a new task is performed increases the overall time and energy required to change an excavator bucket. This “service downtime” equates to loss of time and money to the owner of an excavator.

Accordingly, a need exists for a combined tool that incorporates a sledge hammer, wrench and pin bar to make servicing of an excavator bucket more efficient and cost effective. Other objects of the invention will be apparent from the description that follows.

### SUMMARY OF THE INVENTION

According to the present invention there is provided a combination tool with a hammer and wrench. The tool may include an elongated handle having a first and a second end and a hammer head formed substantially perpendicularly and extending from the first end of the elongated handle. The tool may further include a circumferential wrench wall formed substantially perpendicularly and extending from the first end of the elongated handle and substantially longitudinally and extending away from the hammer head. The wrench wall may include an outer wall surface and an inner wall surface, wherein the inner wall surface may have a cross-sectional perimeter shaped to define a bolt head pattern.

The tool may further include a pin bar formed substantially longitudinally and extending from the second end of the elongated handle and may also include a rubber sleeve that encases the elongated handle from the second end to substantially a mid-point of the elongated handle.

The elongated handle, hammer head, and wrench wall may all be painted orange and may all, including the pin bar be formed from a unitary material, such as steel.

The hammer head may be cylindrically shaped and may be substantially equal in diameter to the circumferential wrench wall as well as substantially equal in length.

The cross-section of the elongated handle may be substantially circularly shaped from the first end to a mid-point of the handle and substantially ovally shaped from the mid-point to the second end.

The tool may have an inside angle between the circumferential wrench wall and the elongated handle of between 90° and 105°.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a perspective view of the combination tool;

FIG. 2 is a plan view of the hammer head of the combination tool along line 2-2 of FIG. 1;

FIG. 3 is a plan view of the wrench head of the combination tool along line 3-3 of FIG. 1; and

FIG. 4 is a plan view of the tool of FIG. 1 in operation.

### DESCRIPTION OF THE PREFERRED EMBODIMENT OF THE INVENTION

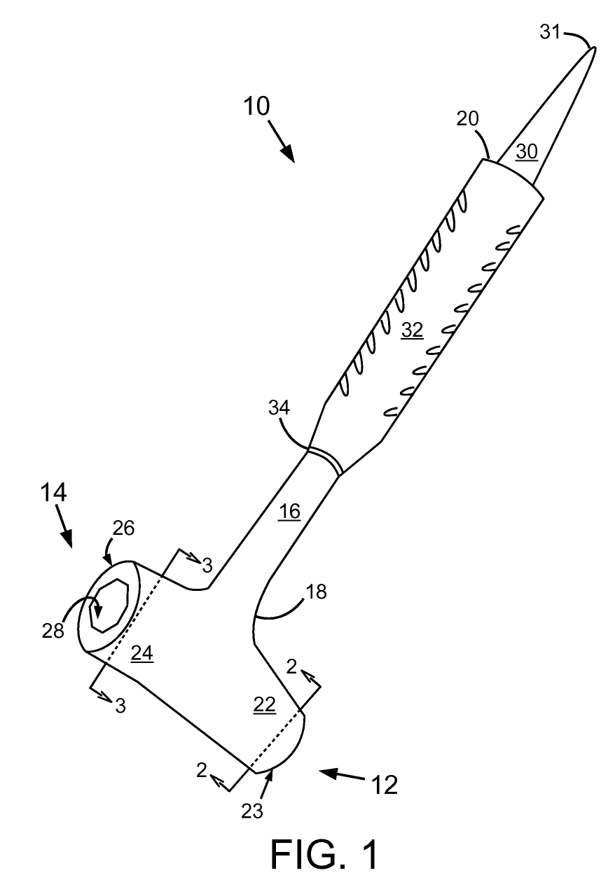

Referring to FIG. 1, a combination tool 10 with a hammer portion 12 and a wrench portion 14 is depicted. The tool 10 includes an elongated handle 16 having a first 18 and a second end 20. A hammer head 22 is formed substantially perpendicularly and extending from the first end 18 of the elongated handle 16. A wrench head in the form of a circumferential wrench wall 24 is also formed substantially perpendicularly and extending from the first end 18 of the elongated handle 16 but is also formed substantially longitudinally and extending away from the hammer head 22. Thus, the hammer head 22 and wrench wall 24 are substantially aligned with one another and sit atop of the first end 18 of the elongated handle 16.

As with conventional hammers, forming the wrench wall 24 opposed to and in alignment with the hammer head 22, balances the tool 10 when a user uses the hammer head 22, as the wrench wall 24 acts as a counterbalance. To further balance the tool 10, the distance the hammer head 22 extends from the first end 18 of the elongated handle 16 is substantially equal to the distance the wrench wall 24 extends from the first end 18 of the elongated handle 16.

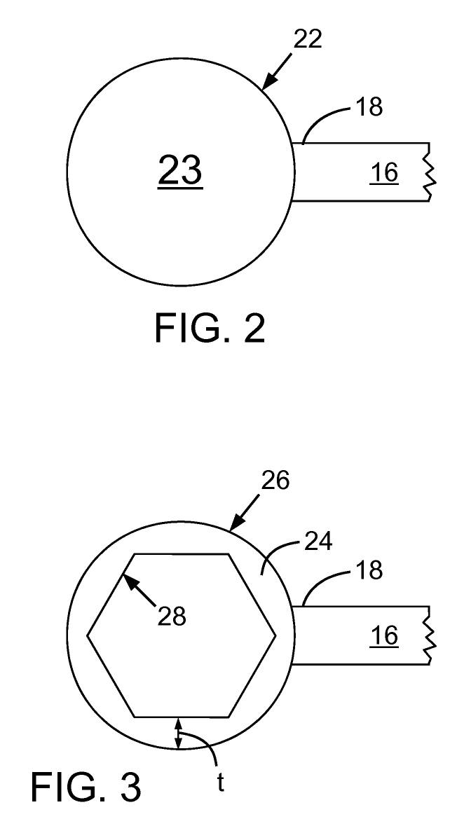

As those skilled in the art will appreciate the shape of the hammer head 22 may be any suitable hammer shape with a pounding surface 23. As shown in FIG. 2, preferably for ease of production, the hammer head 22 is cylindrically shaped to match the wrench wall 22 so that the both are substantially equal in diameter.

Referring to FIG. 3, the wrench wall 24 includes an outer wall surface 26 and an inner wall surface 28. The inner wall surface 28 has a cross-sectional perimeter shaped to define a bolt head pattern. As those skilled in the art will appreciate, any bolt head pattern will do. To match with common excavator bolts, the cross-sectional perimeter of inner wall surface 28 has preferably a hexagonal bolt pattern with a 1½″ drive. The thickness “t” of the wrench wall varies around the wrench head wall 24 and as those skilled in the art will appreciate can be any thickness suitable to withstand wrenching forces.

Referring back to FIG. 1, the tool 10 further includes a pin bar 30 formed substantially longitudinally and extending from the second end 20 of the elongated handle 16. The pin bar 30 may be any suitable shape connected to the second end 20 but tapers to a point 31 so that it can be used as a scraping tool.

To dampen the vibrations experienced by the tool during its use as a hammer and to provide a user with a gripping surface, a rubber sleeve 32 may be included to encase the elongated handle 16. As those skilled in art will appreciate, the length of the rubber sleeve 32 may be of any length, but preferably it encases the elongated handle 16 from the second end 20 to substantially a mid-point 34 of the elongated handle 16.

As those skilled in the art will also appreciate, the cross-sectional shape of the handle 16 may be any suitable shape, but is preferably substantially circularly shaped from the first end 18 to the mid-point 34 of the handle 16 and then substantially ovally shaped from the mid-point 34 to the second end 20.

For safety and to increase the tool's 10 visibility while in use in the field, the elongated handle 16, hammer head 22, and wrench wall 24 may be painted orange. Additionally, if need be the pin bar 30 may also be painted orange.

For ease of production, the elongated handle 16, hammer head 22, wrench wall 24 and pin bar 30 may all be formed from a unitary material, such as steel. As those skilled in the art will appreciate any suitable material may be used.

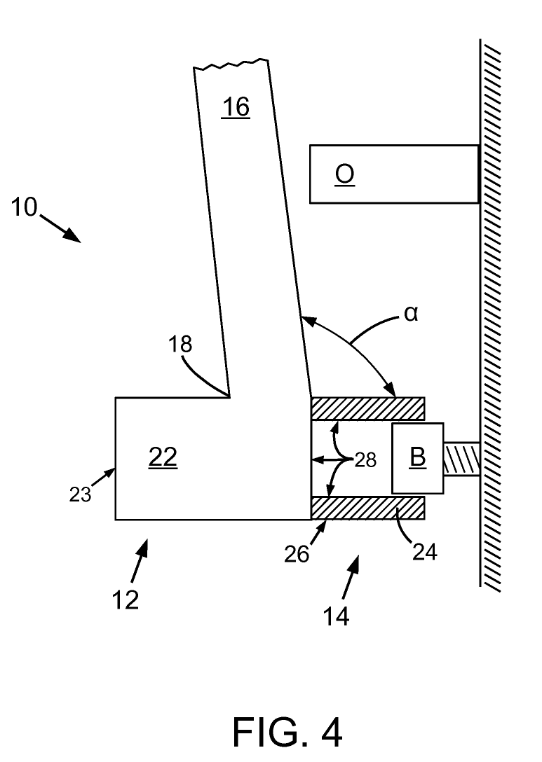

As depicted in FIG. 4, to provide clearance for the handle 16 from an object “O” in its path of movement when the tool 10 is being used to wrench a bolt “B”, the wrench head wall 24 may be offset from the handle. As such, the inside angle “α” between the circumferential wrench wall 24 and the elongated handle 16 can range between 90° and 105°.

It will thus be seen that a new and novel combination tool with hammer and wrench heads has been illustrated and described and it will be apparent to those skilled in the art that various changes and modifications may be made therein without departing from the spirit of the invention.

What is claimed is:

1. A combination tool with a hammer and wrench comprising:
an elongated handle having a first and a second end;
a hammer head formed substantially perpendicularly and extending from said first end of said elongated handle; and
a circumferential wrench wall formed substantially perpendicularly and extending from said first end of said elongated handle and substantially longitudinally and extending away from said hammer head, wherein said wrench wall comprises an outer wall surface and an inner wall surface, wherein said inner wall surface has a cross-sectional perimeter shaped to define a bolt head pattern.

2. The combination tool of claim 1 further comprising a pin bar formed substantially longitudinally and extending from said second end of said elongated handle.

3. The combination tool of claim 1 further comprising a rubber sleeve encasing said elongated handle.

4. The combination tool of claim 3 wherein said rubber sleeve encases said elongated handle from said second end to substantially a mid-point of said elongated handle.

5. The combination tool of claim 1 wherein said elongated handle, hammer head, and wrench wall are painted orange.

6. The combination tool of claim 1 wherein said elongated handle, hammer head, and wrench wall are formed from a unitary material.

7. The combination tool of claim 2 wherein said elongated handle, hammer head, wrench wall, and pin bar are formed from a unitary material.

8. The combination tool of claim 6 wherein said unitary material is steel.

9. The combination tool of claim 1 wherein said hammer head is cylindrically shaped.

10. The combination tool of claim 9 wherein said cylindrical hammer head and said circumferential wrench wall are substantially equal in diameter.

11. The combination tool of claim 1 wherein a distance said hammer head extends from said first end of said elongated handle is substantially equal to a distance said wrench wall extends from said first end of said elongated handle.

12. The combination tool of claim 1 wherein the cross-section of said elongated handle is substantially circularly shaped from said first end to a mid-point of said handle and substantially ovally shaped from said mid-point to said second end.

13. The combination tool of claim 1 wherein an inside angle between said circumferential wrench wall and said elongated handle is between 90° and 105°.

14. The combination tool of claim 7 wherein said unitary material is steel.
